(19) United States
(12) Patent Application Publication
(10) Pub. No.: US 2022/0187649 A1
(43) Pub. Date: Jun. 16, 2022

(54) ELECTRONIC DEVICE AND RELATED DISPLAY DEVICE

(71) Applicant: InnoLux Corporation, Miao-Li County (TW)

(72) Inventors: Chien-Chih LIAO, Miao-Li County (TW); Hsing-Yuan HSU, Miao-Li County (TW); Po-Yang CHEN, Miao-Li County (TW); I-An YAO, Miao-Li County (TW)

(73) Assignee: InnoLux Corporation, Miao-Li County (TW)

(21) Appl. No.: 17/522,909

(22) Filed: Nov. 10, 2021

(30) Foreign Application Priority Data
Dec. 10, 2020 (CN) 202011435343.2

(51) Int. Cl. G02F 1/1362; G06K 9/00

(52) U.S. Cl. CPC G02F 1/13629; G06K 9/0004

(57) ABSTRACT

An electronic device is provided. The electronic device includes a first substrate; a second substrate, disposed opposite to the first substrate; a liquid crystal layer, disposed between the first substrate and the second substrate; a sensing circuit, disposed on the first substrate and having a high voltage wire; and a conductor, disposed between the high voltage wire and the liquid crystal layer; wherein the conductor is less than the high voltage wire in voltage value.

### CROSS REFERENCE TO RELATED APPLICATION

This application claims the benefit of Chinese Patent Application Serial No. 202011435343.2, filed Dec. 10, 2020, the entire content of which is incorporated herein by reference.

### BACKGROUND OF THE DISCLOSURE

### 1. Field of the Disclosure

The present disclosure relates to an electronic device and related display device, and more particularly to an electronic device and a related display device which has fingerprint recognition.

### 2. Description of the Prior Art

Conventional fingerprint recognition devices are utilized in electronic devices such as mobile devices. When the conventional fingerprint recognition devices are integrated in the panel of an electronic device, an additional fingerprint recognition device is needed in the original circuit structure. When the panel is a liquid crystal display, the electric field generated by the high voltage direct current signal lines or the high voltage alternating current signal lines of the fingerprint recognition device might affect the liquid crystal layer of the panel, resulting in abnormal frames on the panel.

### SUMMARY OF THE DISCLOSURE

According to an embodiment of the present disclosure, an electronic device is provided. The electronic device includes a first substrate, a second substrate, disposed opposite to the first substrate, a liquid crystal layer, disposed between the first substrate and the second substrate, a sensing circuit, disposed on the first substrate and having a high voltage wire; and a conductor, disposed between the high voltage wire and the liquid crystal layer; wherein the conductor is less than the high voltage wire in voltage value.

According to an embodiment of the present disclosure, a display device is provided. The display device includes a first substrate; a second substrate, disposed opposite to the first substrate; a liquid crystal layer, disposed between the first substrate and the second substrate; a sensing circuit, disposed on the first substrate and having a high voltage wire; and a conductor, disposed between the high voltage wire and the liquid crystal layer; wherein the conductor is less than the high voltage wire in voltage value.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 schematically illustrates a section view of an electronic device according to an embodiment of the present disclosure.

FIG. 2 schematically illustrates a top view of multiple ITO pads and a high voltage wire of the electronic device according to the embodiment of the present disclosure.

FIG. 3 schematically illustrates a circuit structure of the electronic device according to the embodiment of the present disclosure.

FIG. 4 schematically illustrates an operating method of the electronic device according to the embodiment of the present disclosure.

FIG. 5 schematically illustrates a fingerprint sensing method of the electronic device according to the embodiment of the present disclosure.

FIG. 6 schematically illustrates another circuit structure of the electronic device according to the embodiment of the present disclosure.

FIG. 7 schematically illustrates another circuit structure of the electronic device according to the embodiment of the present disclosure.

FIG. 8 schematically illustrates a section view of an electronic device according to another embodiment of the present disclosure.

FIG. 9 schematically illustrates a top view of an electric field shielding element of an electronic device according to another embodiment of the present disclosure.

FIG. 10 schematically illustrates another circuit structure of the electronic device according to the embodiment of the present disclosure.

### DETAILED DESCRIPTION

Hereinafter, package devices of embodiments of the present disclosure are detailed in the following description. It should be understood that many different embodiments provided below are implemented to different aspects. The following specific components and arrangements describe some embodiments just for simplicity and clarity. Of course, these are just for example and not for limitation. In addition, similar components may be labeled with similar and/or corresponding reference numerals indifferent embodiments for clarity of description. However, these similar reference numbers just describe some embodiments simply and clearly, and do not mean that there is any relationship between different embodiments and/or structures discussed herein.

When a first layer is located on or above a second layer, the first layer may be in direct contact with the second layer. Alternatively, one or more other layers may be spaced between them, and in such case, the first layer may not be in direct contact with the second layer.

The contents of the present disclosure will be described in detail with reference to specific embodiments and drawings. In order to make the contents clearer and easier to understand, the following drawings may be simplified schematic diagrams, and components therein may not be drawn to scale. The numbers and sizes of the components in the drawings are just illustrative, and are not intended to limit the scope of the present disclosure.

Certain terms are used throughout the specification and the appended claims of the present disclosure to refer to specific components. Those skilled in the art should understand that electronic equipment manufacturers may refer to a component by different names, and this document does not intend to distinguish between components that differ in name but not function. In the following description and claims, the terms “comprise”, “include” and “have” are open-ended fashion, so they should be interpreted as “including but not limited to . . . ”. It should also be understood that when a component is said to be “coupled” to another component (or a variant thereof), it may be directly connected to another component or indirectly connected (e.g., electrically connected) to another component through one or more components.

When ordinal numbers, such as “first” and “second”, used in the specification and claims are used to modify components in the claims, they do not mean and represent that the claimed components have any previous ordinal numbers, nor do they represent the order of a claimed component and another claimed component, or the order of manufacturing methods. These ordinal numbers are just used to distinguish a claimed component with a certain name from another claimed component with the same name.

When a component (e.g., film or region) is called “on another component”, it may be directly on the another component, or there may be other components in between. On the other hand, when a component is called “directly on another component”, there is no component between them. In addition, when a component is called “on another component”, there is an upper and lower relationship between the two components in a top view direction, and this component may be above or below the other component, and this upper and lower relationship depends on the orientation of the device.

In this document, the terms “about”, “substantially” and “approximately” usually mean within 10%, 5%, 3%, 2%, 1% or 0.5% of a given value or range. The quantity given here is about the quantity, that is, without specifying “about”, “substantially” and “approximately”, the meanings of “about”, “substantially” and “approximately” may still be implied. In addition, the term “range from a first value to a second value” means that the range includes the first value, the second value and other values between them.

It should be understood that according to the following embodiments, features of different embodiments may be replaced, recombined or mixed to constitute other embodiments without departing from the spirit of the present disclosure. As long as the features of the embodiments do not violate the inventive spirit or conflict with each other, they can be mixed and used at will.

In the present disclosure, the thicknesses, lengths and widths may be measured by optical microscope, in which the thicknesses may be measured from cross-sectional image obtained by electron microscope, but the present disclosure is not limited to this. In addition, any two values or directions used for comparison may have certain errors. If a first value is equal to a second value, it implies that there may be about 10% error between the first value and the second value; if a first direction is perpendicular to a second direction, an angle between the first direction and the second direction may range from 80 degrees to 100 degrees; and if the first direction is parallel to the second direction, the angle between the first direction and the second direction may range from 0 to 10 degrees.

Unless otherwise defined, all terms used herein (including technical and scientific terms) have the same meanings as those commonly understood by those skilled in the art to which the present disclosure belongs. It can be understood that these terms, such as those defined in commonly used dictionaries, should be interpreted as meanings consistent with the background or context of related technologies and the present disclosure, and should not be interpreted in an idealized or overly formal way, unless it is specifically defined in the embodiments of the present disclosure.

Package devices according to various embodiments of the present disclosure are detailed in the following description. It should be understood that the many different embodiments provided below detail different aspects and implementations. The following specific components and arrangements are provided for the purposes of simplicity and clarity. It should be noted that these embodiments are for illustrating the inventive features but the disclosure is not limited thereto. In addition, similar components may be labeled with similar and/or corresponding reference numerals in different embodiments for clarity of description. These repeated reference numbers are merely for describing the embodiments in a simple and clear manner, and do not mean that there is any relationship between the different embodiments and/or structures discussed herein.

When a first layer is located on or above a second layer, the first layer may be in direct contact with the second layer. Alternatively, one or more other layers may be spaced between them, and in such cases, the first layer may not be in direct contact with the second layer.

The contents of the present disclosure will be described in detail with reference to specific embodiments and drawings. In order to make the contents clearer and easier to understand, the following drawings may be simplified schematic diagrams, and components therein may not be drawn to scale. The numbers and sizes of the components in the drawings are merely illustrative, and are not intended to limit the scope of the present disclosure.

Certain terms are used throughout the specification and the appended claims of the present disclosure to refer to specific components. Those skilled in the art should understand that electronic equipment manufacturers may refer to a component by different names, and this document does not intend to distinguish between components that differ in name but not function. In the following description and claims, the terms “comprise”, “include” and “have” are open-ended fashion, so they should be interpreted as “including but not limited to . . . ”. It should also be understood that when a component is said to be “coupled” to another component (or a variant thereof), it may be directly connected to another component or indirectly connected (e.g., electrically connected) to another component through one or more components.

When ordinal numbers, such as “first” and “second”, used in the specification and claims are used to modify components in the claims, they do not mean to represent that the claimed components have any previous ordinal numbers, nor do they represent the order of a claimed component and another claimed component, or the order of manufacturing methods. These ordinal numbers are just used to distinguish a claimed component with a certain name from another claimed component with the same name.

When a component (e.g., a film or region) is described as “on another component”, it may be directly disposed on the other component, or there may be other components in between. On the other hand, when a component is described as “directly on another component”, there is no component in between. In addition, when a component is described as “on another component”, there is an upper and lower relationship between the two components in a top view direction, this component may be above or below the other component, and this upper and lower relationship depends on the orientation of the device.

In this document, the terms “about”, “substantially” and “approximately” usually mean within 10%, 5%, 3%, 2%, 1% or 0.5% of a given value or range. When a quantity is given without specifying “about”, “substantially” and “approximately”, the meanings of “about”, “substantially” and “approximately” may still be implied. In addition, the term “range from a first value to a second value” means that the range includes the first value, the second value and other values between them.

It should be understood that, according to the following embodiments, features of different embodiments may be replaced, recombined or mixed to constitute other embodiments without departing from the spirit of the present disclosure. As long as the features of the embodiments do not violate the inventive spirit or conflict with each other, they can be mixed and used at will.

In the present disclosure, the thicknesses, lengths and widths may be measured by an optical microscope, in which the thicknesses may be measured from a cross-sectional image obtained by an electron microscope, but the present disclosure is not limited thereto. In addition, any two values or directions used for comparison may have certain errors. If a first value is equal to a second value, it implies that there may be about 10% error between the first value and the second value; if a first direction is perpendicular to a second direction, an angle between the first direction and the second direction may range from 80 degrees to 100 degrees; and if the first direction is parallel to the second direction, the angle between the first direction and the second direction may range from 0 to 10 degrees.

Unless otherwise defined, all terms used herein (including technical and scientific terms) have the same meanings as those commonly understood by those skilled in the art to which the present disclosure belongs. It can be understood that these terms, such as those defined in commonly used dictionaries, should be interpreted as meanings consistent with the background or context of related technologies and the present disclosure, and should not be interpreted in an idealized or overly formal way, unless it is specifically defined in the embodiments of the present disclosure.

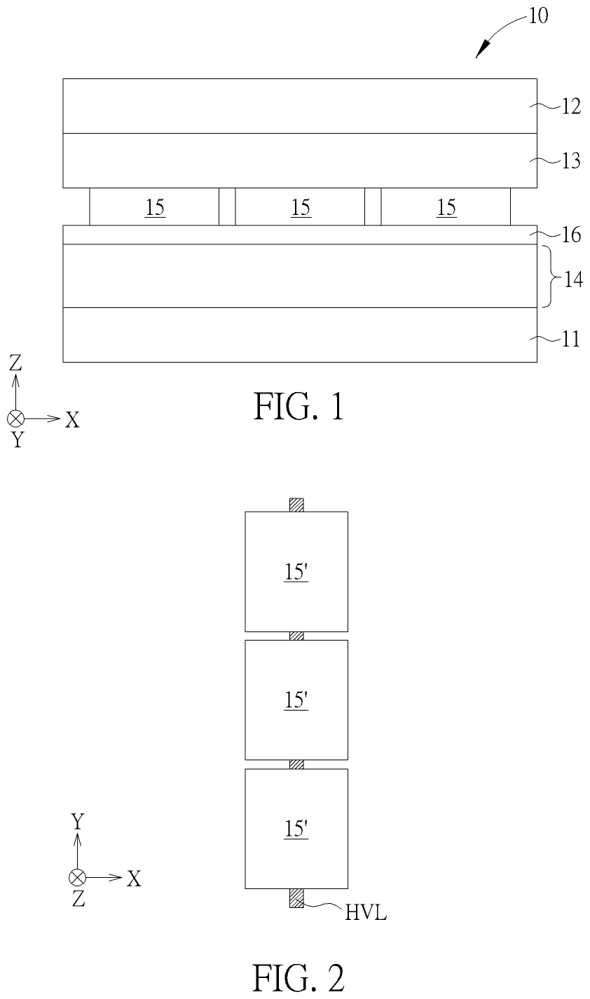

FIG. 1 schematically illustrates a section view of an electronic device 10 according to an embodiment of the present disclosure. The electronic device 10 may be an electronic device having a fingerprint recognition function and/or a touch function, e.g. a mobile phone, a tablet or a display device. The electronic device 10 includes a first substrate 11, a second substrate 12, a liquid crystal layer 13, a sensing circuit 14 and a conductor 15. The second substrate 12 is disposed opposite to the first substrate 11. The liquid crystal layer 13 is disposed between the first substrate 11 and the second substrate 12, wherein the first substrate 11 and the second substrate 12 may respectively be a transparent substrate. A material of the first substrate 11 or the second substrate 12 may be glass, quartz, sapphire or ceramic. In other embodiments, the material of the first substrate 11 or the second substrate 12 may be polycarbonate (PC), polyimide (PI), a polyethylene terephthalate (PET), other appropriate materials or a combination of the above materials are not limited thereto. Please also refer to FIG. 2, which illustrates that the sensing circuit 14 may be a fingerprint sensor, e.g. an in-display fingerprint sensor, disposed on the first substrate 11, having at least a high voltage wire HVL, but not limited thereto. The conductor 15 is disposed between the high voltage wire HVL and the liquid crystal layer 13, and the conductor 15 is less than the high voltage wire VHL in voltage value.

Furthermore, the conductor 15 may comprise multiple Indium Tin Oxide (ITO) pads 15′, wherein the voltage applied to the conductor 15 is a ground voltage and is utilized as a ground wire. An insulating layer 16 may be included between the conductor 15 and the sensing circuit 14, wherein the insulating layer 16 may include organic materials, e.g. polyethylene terephthalate (PET), polyethylene (PE), polyethersulfone (PES), polycarbonate (PC), polymethylmethacrylate (PMMA), polyimide (PI), photo sensitive polyimide (PSPI) or combinations of the above materials. Alternatively, the insulating layer 16 may include inorganic materials, e.g. SiOx, SiNx or combinations of the above materials, but is not limited thereto. In some embodiments, the insulating layer 16 may be a structure comprising a single layer or multiple layers, and/or with a planarization (PLN) function.

FIG. 2 schematically illustrates a top view of the ITO pads 15′ and the high voltage wire HVL of the electronic device 10 according to the embodiment of the present disclosure. As can be seen from FIG. 2, in the top view of the first substrate 11, in a normal direction (i.e. Z-axis direction) of the first substrate 11, the ITO pads 15′ may overlap with part of the high voltage wire HVL. Since the voltage value applied to the conductor 15 is lower than that of the high voltage wire HVL, in an embodiment, the ITO pads 15′ disposed between the liquid crystal layer 13 and the high voltage wire HVL of the sensing circuit 14 may be utilized for shielding the electric field generated when the high voltage wire HVL is in operation so as to reduce the influence on the liquid crystal layer 13. In an embodiment, the electric field may be shielded by the conductor 15 when the high voltage (e.g. 12 volts) is applied to the high voltage wire HVL of the sensing circuit 14 to reduce the influence on the liquid crystal layer 13.

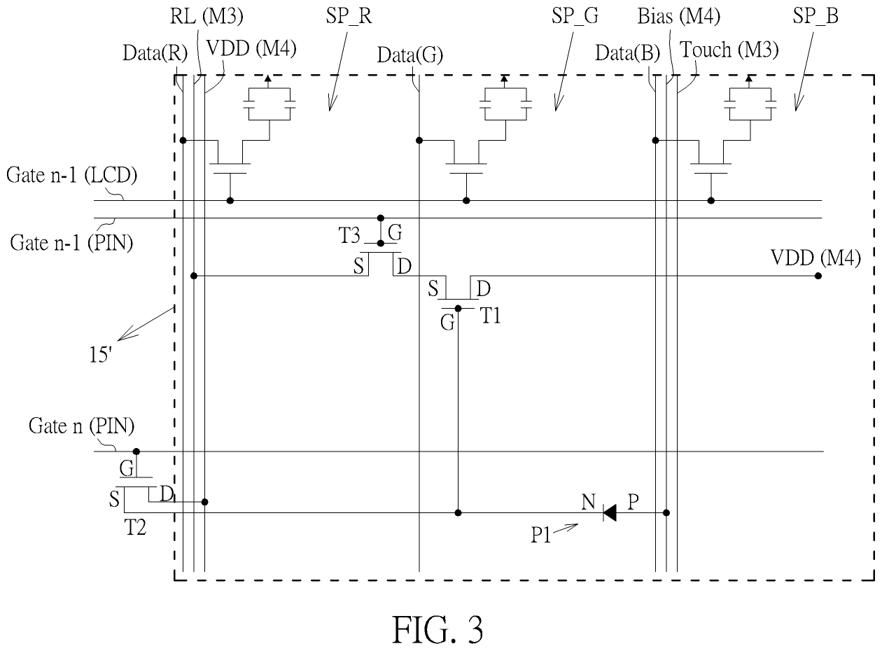

In general, multiple metal layers may be layered along the normal direction (i.e. the Z-axis direction) of the first substrate 11, e.g. a first metal layer M1, a second metal layer M2, a third metal layer M3 and a fourth metal layer M4 are included in the embodiment of FIG. 3, wherein the first metal layer M1 is closest to the first substrate 11 and the first metal layer M1 may be part of a switch element. For example, when the switch element is a thin-film transistor (TFT), the first metal layer M1 may be a gate. Alternatively, the first metal layer M1 may be formed as gate lines Gate. The second metal layer M2 is disposed on the first metal layer M1 and may include data lines Data, the third metal layer M3 is disposed on the second metal layer M2 and may include a read-out line RL, and the fourth metal layer M4 is disposed on the third metal layer M3 and may include a power supply line VDD. An insulating layer may be disposed between each of the first metal layer M1, the second metal layer M2, the third metal layer M3 and the fourth metal layer M4, and is not limited thereto.

FIG. 3 schematically illustrates a circuit structure of the electronic device 10 according to the embodiment of the present disclosure. In an embodiment, the sensing circuit 14 may include a light sensing element P1, a switch element T1, a switch element T2, a switch element T3 and multiple signal lines. The light sensing element P1 is configured to sense a light source and store energy. In an embodiment, the light sensing element P1 may be coupled to other elements, e.g. a capacitor, but not limited thereto. The switch element T1, the switch element T2, and the switch element T3 are coupled to the light sensing element P1 for performing a fingerprint sensing process. Signal lines of the sensing circuit 14 may include the power supply line VDD, the read-out line RL and a reference bias line Bias, wherein the power supply line VDD and/or reference bias line Bias may be coupled to a direct current signal source.

Notably, coverage area of the ITO pads 15′ illustrated in the embodiment of FIG. 3 may include at least a pixel, i.e. include a red subpixel SP_R, a green subpixel SP_G and a blue subpixel SP_B, and overlap with at least some of the multiple signal lines, e.g. a data line Data (R) of the red subpixel SP_R, a data line Data (G) of the green subpixel SP_G and a data line Data (B) of the blue subpixel SP_B, the power supply line VDD and the reference bias line Bias formed by the fourth metal layer M4, the read-out line RL formed by the third metal layer M3, and touch signal lines Touch and elements at different layers. In order to clearly display the signal lines at different layers, the data line Data (R) on the first substrate 11, the power supply line VDD and the read-out line RL are staggered in FIG. 3. That is, in the top view of the electronic device 10, the data line Data (R), the power supply line VDD and the read-out line RL may at least be partially overlapped, but not limited thereto. In addition, in the top view of the electronic device 10, a gate line Gate n−1 (LCD) is not overlapped with gate lines Gate n (PIN) and Gate n−1 (PIN) of the sensing circuit 14. When the electronic device 10 is equipped with a touch function, the conductor 15 may be utilized as a touch electrode. In order to prevent the touch electrode (i.e. the conductor 15) from interfering with the fingerprint sensing of the sensing circuit 14, an operating time of the conductor 15 being the touch electrode and an operating time of the fingerprint sensing of the sensing circuit 14 are multiplexed in a time division method. That is, the sensing circuit 14 is not in operation when the conductor 15 is the touch electrode to prevent interference with the touch function.

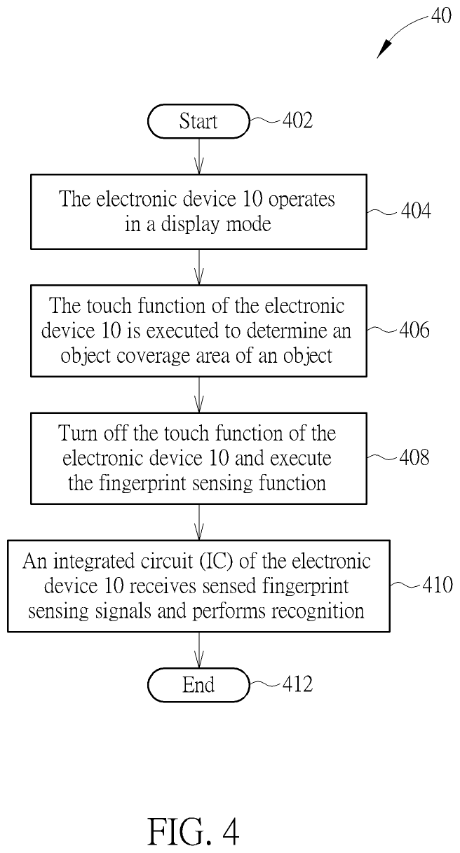

Refer to FIG. 4 for an operation method of the electronic device 10. FIG. 4 schematically illustrates an operating method 40 of the electronic device 10 according to the embodiment of the present disclosure. The operating method 40 includes the following steps:

Step 402: Start.

Step 404: The electronic device 10 operates in a display mode.

Step 406: The touch function of the electronic device 10 is executed to determine an object coverage area of an object.

Step 408: Turn off the touch function of the electronic device 10 and execute the fingerprint sensing function.

Step 410: An integrated circuit (IC) of the electronic device receives sensed fingerprint sensing signals and performs recognition.

Step 412: End.

According to the operating method 40, the electronic device 10 is configured to control the liquid crystal layer 13 for displaying frames in step 404. In step 406, the touch function is executed to determine that the object touches the area of the electronic device 10 (i.e. the object coverage area). The object touching the electronic device 10 may be a finger, but is not limited thereto. Then, in step 408, the touch function of the electronic device 10 is turned off to execute the fingerprint sensing function. Meanwhile, the ground voltage is applied to the ITO pads 15′ for executing the touch function to reduce the interference of the high voltage wire HVL of the sensing circuit 14 to the liquid crystal layer 13. In step 410, the IC of the electronic device 10 receives the fingerprint sensing signals for recognition. Notably, a time period for executing the fingerprint sensing function is a display time of multiple frames before the IC of the electronic device 10 receives the fingerprint sensing signals.

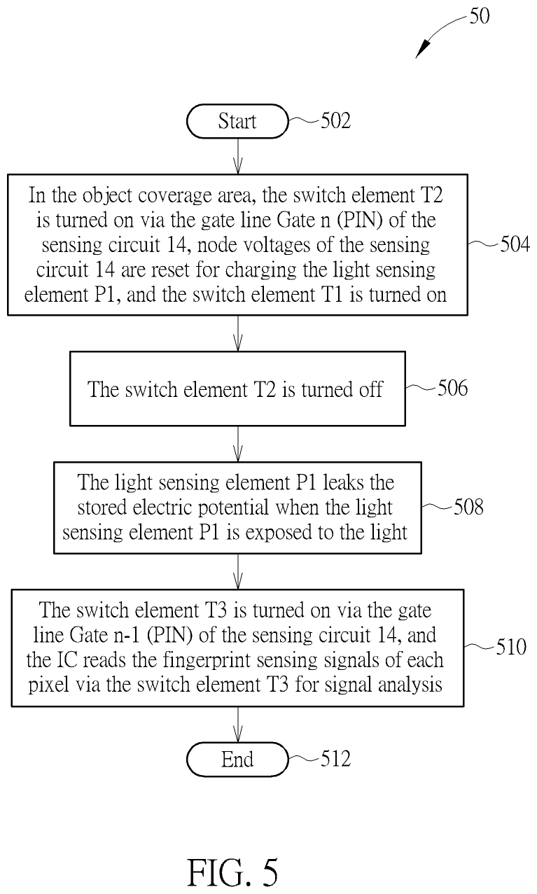

In an embodiment, the fingerprint sensing function of the electronic device 10 according to an embodiment of the present disclosure may further include a fingerprint sensing method 50. Refer to FIG. 5, which schematically illustrates the fingerprint sensing method 50 of the electronic device 10 according to the embodiment of the present disclosure. The fingerprint sensing method 50 includes the following steps:

Step 502: Start.

Step 504: In the object coverage area, the switch element T2 is turned on via the gate line Gate n (PIN) of the sensing circuit 14, node voltages of the sensing circuit 14 are reset for charging the light sensing element P1, and the switch element T1 is turned on.

Step 506: The switch element T2 is turned off.

Step 508: The light sensing element P1 leaks the stored electric potential when the light sensing element P1 is exposed to the light.

Step 510: The switch element T3 is turned on via the gate line Gate n−1 (PIN) of the sensing circuit 14, and the IC reads the fingerprint sensing signals of each pixel via the switch element T3 for signal analysis.

Step 512: End.

According to the fingerprint sensing method 50, the switch element T2 is turned on via the gate line Gate n (PIN) of the sensing circuit 14 in the object coverage area, and the node voltages of the sensing circuit 14 are reset for charging the light sensing element P1. The light sensing element P1 may be a PIN diode, with an N terminal (N) and a P terminal (P), but not limited thereto. In an embodiment, a drain terminal (D) of the switch element T2 is coupled to the power supply line VDD (e.g. the high voltage signal line with up to 12 volts). Taking the light sensing element P1 of the PIN diode as an example, a source terminal (S) of the switch element T2 is electrically connected to the N terminal of the PIN diode, the electric potential of the high voltage signal is transmitted to the N terminal of the PIN diode via the switch element T2 to reset the node voltages of the sensing circuit 14 so as to maintain a high voltage potential among the source terminal (S) of the switch element T2, a gate terminal (G) of the switch element T1 and the N terminal of the light sensing element P1 to turn on the switch element T1. In addition, the reference bias line Bias is coupled to the P terminal of the PIN diode, and the light sensing element P1 is in a state of reverse bias. In step 506, the gate terminal of the switch element T1 is turned on and the switch element T2 is turned off.

In step 508, since the object touching the electronic device 10 is larger than the pixels, the object covers multiple pixels, i.e. the object covers the light sensing element P1 in each of the multiple pixels. When the object is a finger, which includes ridges and valleys, a reflective light generated by the ridges is stronger than that of the valleys, and thus the intensities of different reflective lights generated corresponding to different positions of the fingerprint are different. Moreover, since the light sensing element P1 is in the reverse bias state, the light sensing element P1 of different pixels receives the reflective lights with different intensities, and thereby different leakage currents are generated by the light sensing element P1 of different pixels. As such, a speed of voltage leakage of the N terminal the light sensing element P1 is not consistent due to the different leakage currents. The light intensity sensed by the light sensing element P1 corresponding to the fingerprint ridges is higher, and thus with higher leakage current after the fingerprint sensing, i.e. the fingerprint sensing signals of the N terminal (N) of the light sensing element P1 corresponding to the fingerprint ridges are of lower voltage values. In step 510, the gate line Gate n−1 (PIN) of the sensing circuit 14 turns on the switch element T3, and transmits the fingerprint sensing signals of each pixel to the IC of the electronic device 10 via the switch element T3, which is coupled to the read-out line RL. Since remaining voltage values of each pixel are not identical after the leakage, the remaining voltage values of each pixel may be respectively analyzed for the displayed fingerprint.

Therefore, based on the structure of the circuit of the ITO pads 15′ of the electronic device 10 of the present disclosure, the fourth metal layer M4 is utilized as the signal line with the high voltage signal, e.g. the power supply line VDD shown in FIG. 3, to shield the electric field generated by the high voltage signal of the fourth metal layer M4 and avoid influence to the liquid crystal layer 13.

In an embodiment, a first distance exists between the third metal layer M3 and the fourth metal layer M4 along the normal direction (i.e. the Z-axis direction) of the first substrate 11 and a second distance exists between the fourth metal layer M4 and the ITO pads 15′, wherein the first distance is larger than the second distance, to reduce a parasitic capacitance equivalently sensed by the read-out line RL to improve a driving ability of the sensing circuit 14. The first distance is a shortest distance between the third metal layer M3 and the fourth metal layer M4, and the second distance is a shortest distance between the fourth metal layer M4 and the ITO pads 15′.

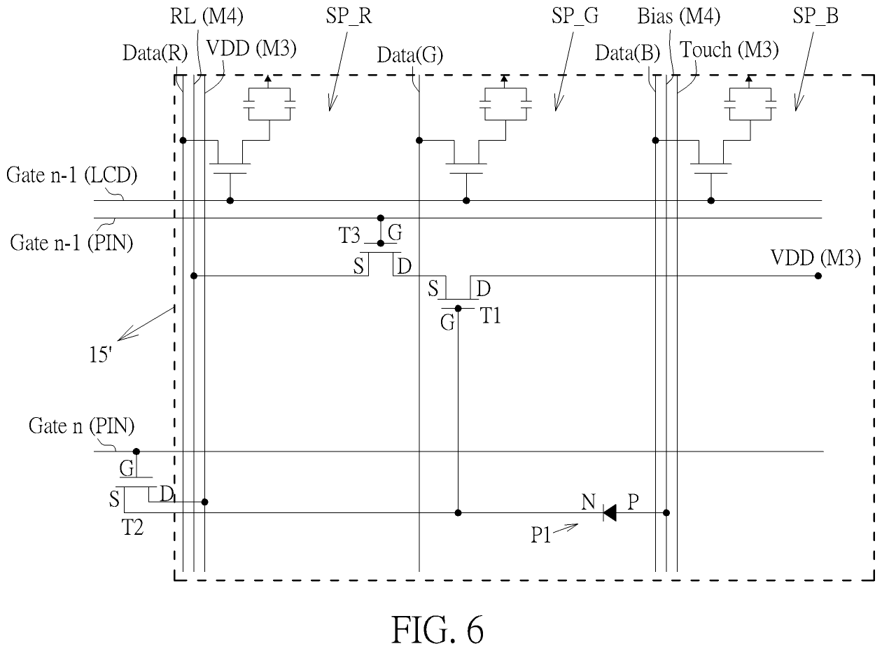

FIG. 6 schematically illustrates another circuit structure of the electronic device 10 according to the embodiment of the present disclosure. The embodiment in FIG. 6 is a modified embodiment of FIG. 3, and inherits the numeral signs of FIG. 3. Different from FIG. 3, the read-out line RL of FIG. 6 is formed by the fourth metal layer M4, the power supply line VDD is formed by the third metal layer M3. In this case, since an insulating layer (not illustrated in FIG. 6) is included between the fourth metal layer M4 and the third metal layer M3, the high voltage (e.g. up to 12 volts) generated by the power supply line VDD may be shielded by the insulating layer and the ITO pads 15′ to reduce the influence of the electric field to the liquid crystal layer 13.

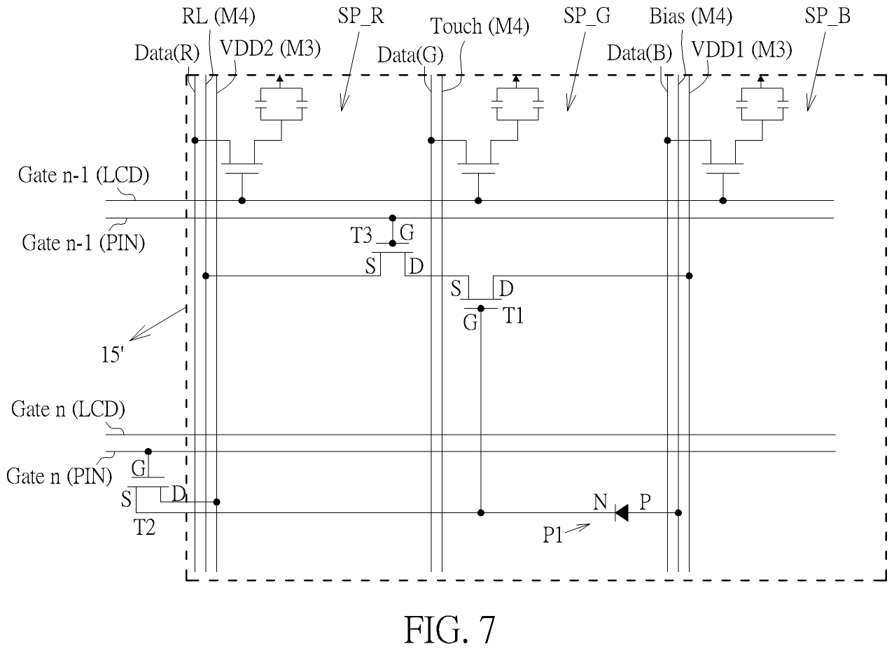

FIG. 7 schematically illustrates another circuit structure of the electronic device 10 according to the embodiment of the present disclosure. The embodiment in FIG. 7 is a modified embodiment of FIG. 3, and inherits the numeral signs of FIG. 3. Different from FIG. 3, a drain terminal of the switch element T1 and the drain terminal (D) of the switch element T2 are respectively coupled to different power supply lines in FIG. 7. The drain terminal (D) of the switch element T1 is coupled to a first power supply line VDD1, and the drain terminal (D) of the switch element T2 is coupled to a second power supply line VDD2 to increase a flexibility of the circuit layout of the electronic device 10. In addition, voltage levels of the first power supply line VDD1 and the second power supply line VDD2 may not be identical, but this is not limited thereto.

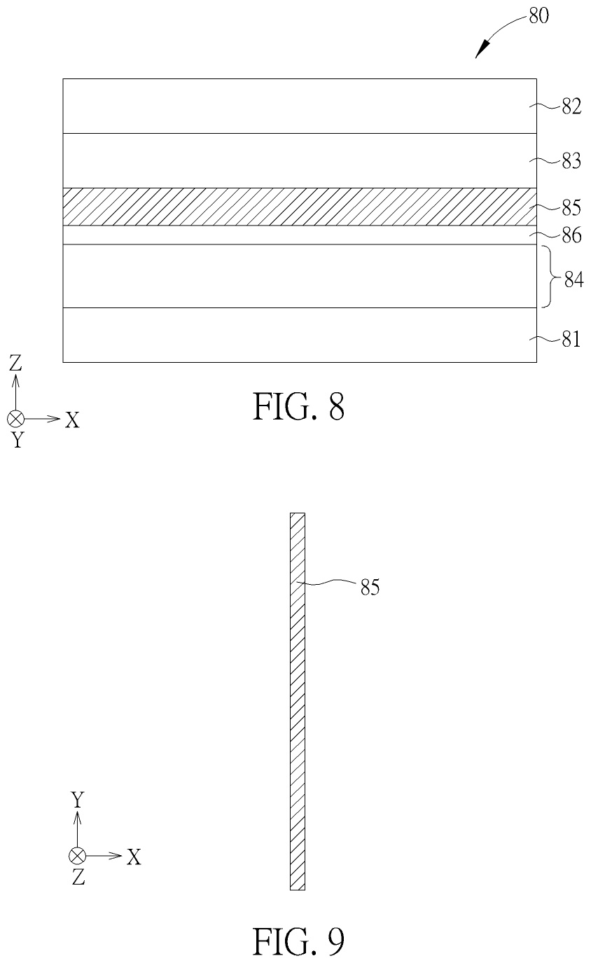

FIG. 8 schematically illustrates a section view of an electronic device 80 according to another embodiment of the present disclosure. The electronic device 80 may be an electronic device having an in-display fingerprint recognition function and a touch function, e.g. a mobile phone, a tablet or a display device. The electronic device 80 includes a first substrate 81, a second substrate 82, a liquid crystal layer 83, a sensing circuit 84 and an electric field shielding element 85. Different from the electronic device 10, the touch function of the electronic device 80 may be applied to a touch on display (TOD) or a window integrated sensor (WIS). The second substrate 82 is disposed opposite to the first substrate 81. The liquid crystal layer 83 is disposed between the first substrate 81 and the second substrate 82, wherein the first substrate 81 and the second substrate 82 may be a transparent substrate, the materials are as stated above, and are not repeated herein. The sensing circuit 84 is disposed on the first substrate 81 and has a high voltage wire HVL. The electric field shielding element 85 is disposed between the high voltage wire HVL and the liquid crystal layer 83, and the electric field shielding element 85 has a lower voltage value than the high voltage wire HVL, wherein the sensing circuit 84 may be a fingerprint sensor.

A low voltage signal line (about 0-5 volts) of the sensing circuit 84 may be utilized as the electric field shielding element 85, i.e. the voltage value applied to the electric field shielding element 85 is lower than that of the high voltage wire HVL (e.g. up to 12 volts). In addition, an insulating layer 86 may be included between the electric field shielding element 85 and the sensing circuit 14, the materials and functions of the insulating layer 86 are as stated above, and are not repeated herein.

FIG. 9 schematically illustrates a top view of the electric field shielding element 85 of the electronic device 80 according to another embodiment of the present disclosure. As can be known from FIG. 9, in the top view, the electric field shielding element 85 may shield the high voltage wire HVL (not shown in FIG. 9) of the sensing circuit 84; therefore, the high voltage wire HVL is not visible in the top view in FIG. 9. In other words, the electric field shielding element 85 between the liquid crystal layer 83 and the high voltage wire HVL of the sensing circuit 84 may shield the high voltage wire HVL when in operation and avoid the influence to the liquid crystal layer 13, which reduces the influence of the electric field to the liquid crystal layer 83, generated when there is a high voltage (e.g. 12 volts) on the high voltage wire HVL of the sensing circuit 84.

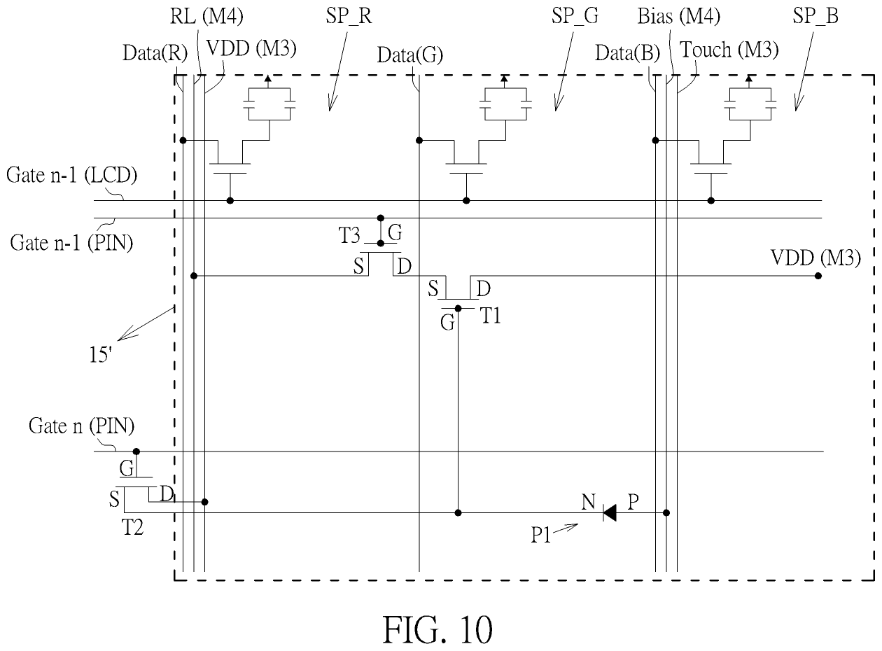

FIG. 10 schematically illustrates another circuit structure of the electronic device 80 according to the embodiment of the present disclosure. The embodiment in FIG. 10 is a modified embodiment of FIG. 3, and inherits the numeral signs of FIG. 3. Different from FIG. 3, the read-out line RL of the sensing circuit 84 in FIG. 10 is formed by the fourth metal layer M4, and the power supply line VDD is formed by the third metal layer M3. Since a voltage value on the read-out line RL is lower, the electronic device 80 may shield the power supply line VDD via the read-out line RL to reduce the influence of the high voltage signal of the power supply line VDD to the liquid crystal layer 83.

In summary, the present disclosure provides an electronic device and a display device for an in-display fingerprint recognition, which shields an influence of an electric field generated by a high voltage wire to the liquid crystal layer and combines the in-display fingerprint recognition and a conventional touch panel.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An electronic device, comprising:
a first substrate;
a second substrate, disposed opposite to the first substrate;
a liquid crystal layer, disposed between the first substrate and the second substrate;
a sensing circuit, disposed on the first substrate and having a high voltage wire; and
a conductor, disposed between the high voltage wire and the liquid crystal layer;
wherein the conductor is less than the high voltage wire in voltage value.

2. The electronic device as claimed in claim 1, wherein the sensing circuit is a fingerprint sensor.

3. The electronic device as claimed in claim 1, wherein the high voltage wire is a power line.

4. The electronic device as claimed in claim 1, wherein the high voltage wire is a read-out line.

5. The electronic device as claimed in claim 1, wherein a voltage applied to the conductor is a ground voltage.

6. The electronic device as claimed in claim 1, wherein the electronic device is a display device.

7. The electronic device as claimed in claim 1, wherein the sensing circuit comprises:
a light-sensing element; and
a plurality of switch elements, coupled to the light-sensing element.

8. The electronic device as claimed in claim 7, wherein the high voltage wire is coupled to the light-sensing element.

9. The electronic device as claimed in claim 1, wherein the conductor includes transparent conductive material.

10. The electronic device as claimed in claim 8, wherein the transparent conductive material includes Indium tin oxide (ITO).

11. A display device, comprising:
a first substrate;
a second substrate, disposed opposite to the first substrate;
a liquid crystal layer, disposed between the first substrate and the second substrate;
a sensing circuit, disposed on the first substrate and having a high voltage wire; and
a conductor, disposed between the high voltage wire and the liquid crystal layer;
wherein the conductor is less than the high voltage wire in voltage value.

12. The display device as claimed in claim 11, wherein the sensing circuit is a fingerprint sensor.

13. The display device as claimed in claim 11, wherein the high voltage wire is a power line.

14. The display device as claimed in claim 11, wherein the high voltage wire is a read-out line.

15. The display device as claimed in claim 11, wherein a voltage applied to the conductor is a ground voltage.

16. The display device as claimed in claim 11, wherein the electronic device is a display device.

17. The display device as claimed in claim 11, wherein the sensing circuit comprises:
a light-sensing element; and
a plurality of switch elements, coupled to the light-sensing element.

18. The display device as claimed in claim 17, wherein the high voltage wire is coupled to the light-sensing element.

19. The display device as claimed in claim 11, wherein the conductor includes transparent conductive material.

20. The display device as claimed in claim 18, wherein the transparent conductive material includes Indium tin oxide (ITO).
